(19) United States
(12) Patent Application Publication
(10) Pub. No.: US 2018/0053163 A1
(43) Pub. Date: Feb. 22, 2018

(54) REWARD, REVIEW AND GROUP PAYMENT SYSTEM

(71) Applicant: Jawaad Khanani, Orlando, FL (US)

(72) Inventor: Jawaad Khanani, Orlando, FL (US)

(21) Appl. No.: 15/679,278

(22) Filed: Aug. 17, 2017

Related U.S. Application Data
(60) Provisional application No. 62/376,173, filed on Aug. 17, 2016.

(51) Int. Cl. G06Q 20/10; G06Q 20/34; G06Q 20/32; G06Q 30/02

(52) U.S. Cl. CPC G06Q 20/105; G06Q 20/351; G06Q 30/0282; G06Q 20/3221; G06Q 20/3226

(57) ABSTRACT

A system and computer implemented method for providing improved communication and payment options between merchants and consumers includes at least one user interface device for operation by a consumer, at least one merchant interface device for operation by a merchant, a system services environment comprising at least one computer system, at least one database, and a communications network. The system can include a plurality of secure user vaults that are linked to a user's financial institution to receive funds therefrom. The received funds are deposited into the user vault, and can be used to purchase goods and services from system merchants or to be transferred between system users. The system includes functionality for generating virtual credit cards that are tied to the funds stored within a user's vault and functionality for leaving merchant reviews which are shared with other system users.

### CROSS-REFERENCE TO RELATED APPLICATIONS

This application claims the benefit of U.S. Application Ser. No. 62/376,173 filed on Aug. 17, 2016, the contents of which are incorporated herein by reference.

### TECHNICAL FIELD

The present invention relates generally to systems and methods directed toward online advertisement, sales and multi-user communication.

### BACKGROUND

The statements in this section merely provide background information related to the present disclosure and may not constitute prior art.

Over the past several years, the percentage of products and services purchased over the internet and/or utilizing electronic devices has grown substantially. As a result, many traditional brick and mortar companies are embracing new technologies that blend the features of traditional payment mechanisms (e.g., credit cards) with new e-commerce systems, so as to attract customers to visit their locations.

In this regard, when visiting a merchant location there are many occasions where it would be beneficial to share the costs associated with the purchase of a good or service between multiple customers. For example, when friends eat at a restaurant and it is time to pay the bill, the current standard is to request the restaurant to split the check between the parties. Such a situation is unpopular with restaurants as it requires the server to spend additional time separating and reprinting checks, and then going through the process of collecting multiple payments for what was originally a single transaction.

Although there are several types of existing mobile-pay platforms, each of these platforms follow a traditional banking method by simply facilitating a 1-to-1 transfer of funds from the user's bank account to the merchant account. As such, each transaction made by the user encounters fees from their financial institution. Moreover, the financial institution is left with a record showing the users spending habits, and the details of each the transaction made by the user. This information, according to multiple reports, is often sold to third party advertisers who may solicit customers based on their spending habits, thus causing an invasion of the users' privacy with no benefit to the users themselves. As such, many privacy-oriented consumers are turning to pre-paid credit cards, which are not able to conduct electronic transactions.

In addition to the above, social media sites have drastically changed the way that people communicate. Whether it be with friends, family or other users who share common interests, social media sites have allowed individuals to express themselves and make new friends based on any number of shared interests. To this end, it is increasingly common for merchants to request customers to leave reviews on social media sites and to reward users for doing so. Unfortunately, many users forget to ever leave a review and, therefore, are unable to be rewarded for visiting a particular merchant.

Accordingly, it would be beneficial to provide a single system which can allow users to create any number of virtual credit cards for anonymous spending, and to confidentially transfer funds between group members, seamlessly share group costs and be rewarded for leaving reviews of participating merchants, without the drawbacks described above.

### SUMMARY OF THE INVENTION

The present invention is directed to a system for providing improved communication and payment options between merchants and consumers. One embodiment of the system can include at least one user interface device for operation by a consumer, at least one merchant interface device for operation by a merchant, a system services environment comprising at least one computer system, at least one database, and a communications network that is connected to each of the at least one user interface device, the at least one merchant interface device, the system services environment and at least one financial institution.

The system can include a plurality of secure user vaults which can be linked to a user's financial institution to receive funds therefrom. The received funds can be deposit into the user vault, and can be used to purchase goods and services from system merchants. The funds can be transferred between system users and used to pay shared bills and other expenses.

In one embodiment, the system can include functionality for generating virtual credit cards that are tied to the funds stored within a user's vault. Users may customize their virtual credit cards and can utilize the cards for purchases without providing identifying information to merchants.

In another embodiment, the system can include functionality for allowing users to review and/or rate the services they receive from system merchants. The reviews can be left during a financial transaction, so as to ensure the reviews are genuine. Merchants can provide promotions to system users based on reviews, and users can share the reviews with other system users.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows one exemplary system for providing improved communication and payment options between merchants and consumers.

FIG. 2 shows an exemplary flow diagram illustrating a method for connecting a user vault with a financial institution using the system.

FIG. 3A shows an exemplary user interface of the system of FIG. 1.

FIG. 3B shows another exemplary user interface of the system of FIG. 1.

FIG. 4A shows another exemplary user interface of the system of FIG. 1.

FIG. 4B shows another exemplary user interface of the system of FIG. 1.

FIG. 5 shows another exemplary user interface of the system of FIG. 1.

FIG. 6 shows another exemplary user interface of the system of FIG. 1.

FIG. 7A shows an exemplary flow diagram illustrating a method for requesting funds from a contact using the system.

FIG. 7B shows another exemplary user interface of the system of FIG. 1.

FIG. 8 shows another exemplary user interface of the system of FIG. 1.

FIG. 9A shows an exemplary flow diagram illustrating a method for creating a virtual credit card using the system.

FIG. 9B shows another exemplary user interface of the system of FIG. 1.

FIG. 10 shows an exemplary flow diagram illustrating a method for paying a merchant using a legacy processing network through the system.

FIG. 11 shows an exemplary flow diagram illustrating a method for paying a merchant using a QR code through the system.

FIG. 12 shows another exemplary user interface of the system of FIG. 1.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### DEFINITIONS

As described throughout this document, the terms “user” “system user” and “consumer” can be used interchangeably to describe any person using the below described system to conduct a financial transaction, leave a review and/or receive a reward.

The terms “merchant” and “company” are used interchangeably to describe any individual, group or legal entity that is promoting, selling or otherwise providing items of commerce such as goods or services, to consumers utilizing the below described system. To this end, merchants may participate in all aspects of the system (e.g., payments, reviews and rewards) or may choose to only participate in a portion of the available services offered by the system.

The terms “system management” and “system administrator” are used interchangeably, to describe the individual, group or legal entity that is overseeing, providing and/or performing various aspects of the below described system. More specifically, such terms describe the individuals overseeing the system services environment 150.

As described herein, the terms “user vault” “personal vault” and derivatives thereof shall refer to a system-implemented bank account, similar to a traditional checking account, into which a user can transfer funds from one or more financial institutions. Each user vault will hold user funds to be spent by the user via the system. In this regard, user funds held within their personal vault can be used to pay for purchases from merchants, transferred to other users, and/or used to fund any number of virtual credit cards that allow system users to make anonymous purchases using either the proprietary payment processing and/or a legacy card processing service.

As described herein, a “card processing network” describes a credit card processing company which interact with financial institutions to process credit card transactions such as Visa®, Mastercard®, and American Express®, for example.

In the preferred embodiment, various aspects of the reward, review and group payment system can be presented in the form of a smartphone mobile application (i.e., App) which can be preloaded onto a smartphone device, or downloaded and installed as an application after purchase of the smartphone device. Of course, the inventive concepts disclosed herein are not to be construed as limiting to a smartphone App, as virtually any type of instruction sets, in any form of programming language that can be executed on a processor enabled device are also contemplated.

Moreover, although illustrated throughout this document as utilizing a user-portable electronic device in the form of a smartphone, the invention is not so limiting. To this end, those of skill in the art will recognize that any type of processor enabled device that is capable of receiving user instructions and communicating information with a secondary device can be utilized herein. As such, various embodiments of the present system can also be performed wherein the portable electronic device comprises a purpose built machine that is pre-encoded with the below described application interface, so as to perform the functionality so described.

In either instance, the disclosed technology addresses the need in the art for a seamless process to allow users to share and transfer funds between group members, while also being incentivized for leaving reviews for participating merchants.

As will be described below, the system 100 can comprise an electronic payment system for mobile devices that facilitate fast, convenient and secure transactions using any cell phone or mobile device. Users can transfer funds from their banking institutions into a personal vault supplied within the system. These funds can be used to create any number of virtual credit cards (also referred to herein as WAADCards), and can pay for goods and services with participating merchants. System users can also create networks of friends with whom they may share costs, transfer funds and review merchant services.

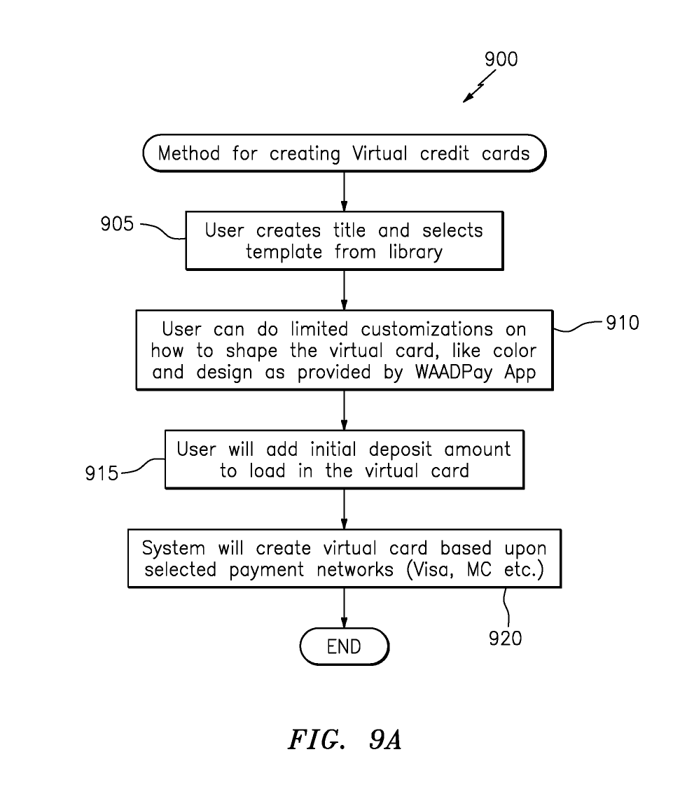

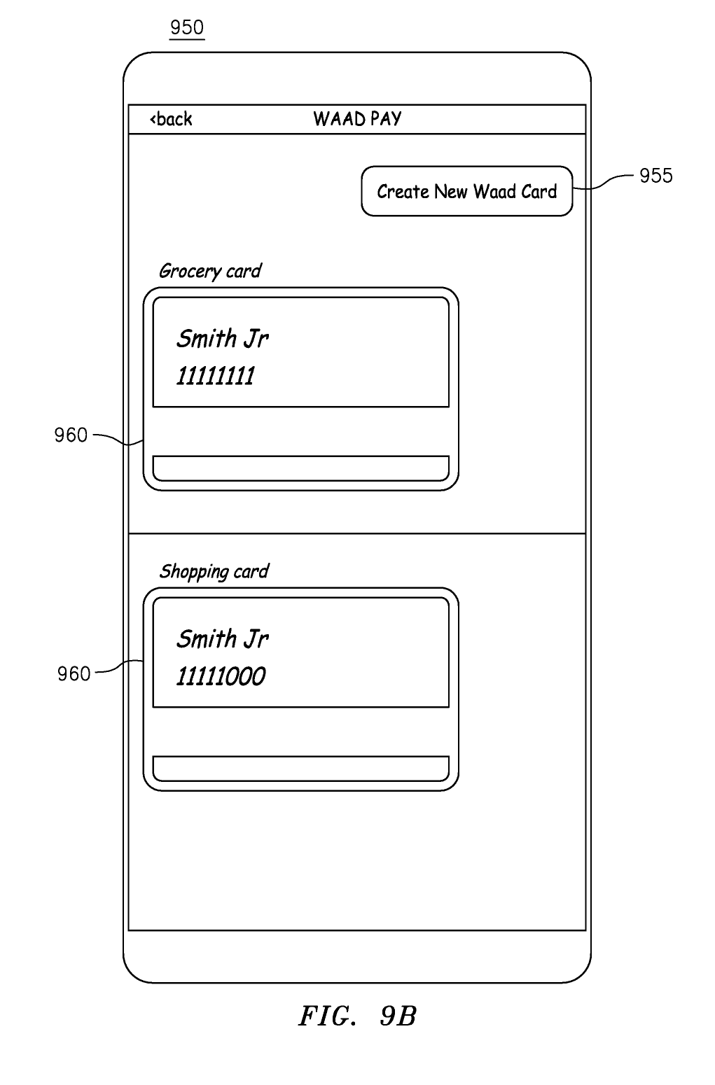

As described herein, the virtual cards created by system users can comprise any number of disposable and reloadable cards, which can include funds of any amount. As described below at FIGS. 9A and 9B, system users can create any number of different virtual cards and can customize the same. These virtual cards can function in a similar manner to a traditional debit card, wherein funds from the users vault will be used when making purchases with the card.

In various embodiments, virtual cards can be established by parents for their children, and the parents can track purchases made by children using their card.

In various embodiments, the system can provide security safeguards for the virtual cards, by allowing users to instantly delete cards to protect from fraud and un-authorized charges. Moreover, because the cards are virtual, the original identity of user and their spending habits are kept private, therefore preventing merchants and/or the user's financial institution to track the same.

In some embodiments, the system can provide a proprietary payment processing network for processing financial transactions between system users and system merchants. Transactions using the proprietary payment network may be conducted wholly “in house” without the need to utilize a legacy network to generate a physical or virtual card. Such a feature ensures that the users' identity will be unknown to the Merchant, so as to ensure a completely private and secure financial transaction.

Proprietary payment transactions can be performed via the below described QR scanning, and/or using any of the payment options through the App. The proprietary system can also utilize NFC technology to communicate payment information between a user's device, and a merchant device onto which the App has also been installed. Additional security can be provided through user authentication such as pin codes and/or biometric authentications, as are known in the art.

In addition to purchasing goods and services, some embodiments of the system can allow users to seamlessly and confidentially transfer funds from one user vault to another either directly or through the use of virtual credit cards. This can be accomplished, for example, by creating a friend and family network with whom funds can be sent and received.

In some embodiments, the system can include functionality for allowing users to provide reviews for goods and services offered by participating merchants. These reviews can be instantly shared with the user's family and friend network. Users from the network can also write comments on the original review, and can re-share the same within their own network of friends and family after making a purchase with the participating merchant. These reviews will be shared within the selected pool of users of the App, by the person initiating the review.

In some embodiments, the system can include a reward system for users of the App. The reward system can give points to a user for reviewing merchant goods and services, as well as for sharing comments with their family and friend network. These rewards can include discounts on future products, cash back offers, deals and other incentives like gold, platinum tier levels. The more a user uses the App to make payments, the higher the status level he/she will attain. The higher levels will be such as Silver member, Gold member, Platinum level etc. The higher the level of membership a user attains based on the app usage and feedbacks, the more the benefits to users, such as cashback, deals and incentives.

The system can include functionality for allowing merchants to push their promotions and offers which can be displayed on the user device of system users. In some embodiments, the system can include functionality for allowing such promotions to be automatically sent to the electronic device of system users whenever it is determined that the user is within a set proximity of the merchant. Such a service can be referred to as WAAD Radar, and can assist users in locating merchants in a nearby area that take payments via the WAADPay App.

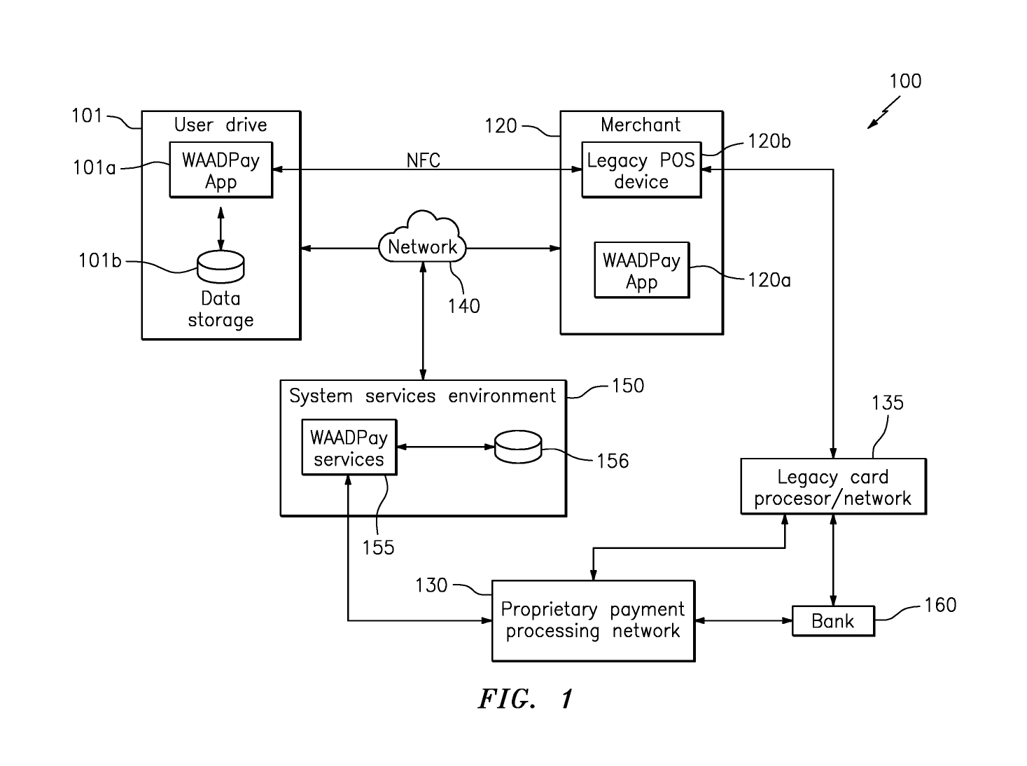

FIG. 1 illustrates one embodiment of a system for providing improved communication and payment options between merchants and consumers 100 that is useful for understanding the inventive concepts disclosed herein. The system 100 can include, for example, any number of user interface devices 101, and any number of merchant interface devices 120, that can be connected over a network 140 to a system services environment 150 and any number of financial institutions 160 via interface networks 130 and/or 135.

Each of the one or more interface devices 101 and 120 can be any form of computing device such as a computer, tablet, smart phone or other such processor enabled device that can be operated by a human user. Each of the devices can include one or more client applications such as the WAADPay App 101a and 120a, respectively, which can allow the interface device user to communicate with other devices over the network 140.

The system services environment 150, can function to facilitate electronic communications between the interface devices of users and merchants to allow users to make purchases, transfer funds, leave online reviews and receive merchant rewards. In various embodiments, the system services environment 150 includes, comprises or consists of one or more individual computing devices 155 that are connected to one or more databases 156 on which various portions of the system and method can be performed.

The system services environment 150 can function to provide a central hub for controlling and facilitating communication between the user interface devices 101, the merchant interface devices, the interface networks 130 and 135, and the financial institutions 160. The system services environment can also house and maintain a plurality of security enhanced user vaults into which system users can deposit funds. This can be accomplished through any number of different mediums such as the above noted App, one or more websites, and/or point of sale terminals 120b, for example. In this regard, one or more of the individual computing devices 155 can comprise a web server, an email server, an application database server and so forth, or the system can employ a single server device which functions to handle each of these processes.

The database 156 can function to receive and store any form of information, and can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. In addition, the devices can be operatively coupled to a communications network, such as network 140, to receive instructions and/or data from the network and/or to transfer instructions and/or data to the network.

The database can function to house any number of computer program products, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

The network 140 can be any type of network, including a local area network (“LAN”), such as an intranet, a wide area network (“WAN”), such as the internet, or any combination thereof. Further, the communication network 140 can be a public network, a private network, or a combination thereof. The communication network 140 can also be implemented using any number of communications links associated with one or more service providers, including one or more wired communication links, one or more wireless communication links, or any combination thereof. Additionally, communication network 140 can be configured to support the transmission of data formatted using any number of protocols.

To facilitate communication with other computing devices, each of the interface devices can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

A legacy card processing service 130 can function to process traditional credit card transactions such as VISA and MASTERCARD, for example, between a banking institution 160 and the user. Such transactions can be performed through the merchant Point of Sale device 120b and/or via such a card that is stored on in the memory 101b of the user device 101 and communicated via NFC. Additionally, the system can include a proprietary payment processing service 135, which can facilitate transactions between a banking institution 160 and the site environment to which the users vault is connected.

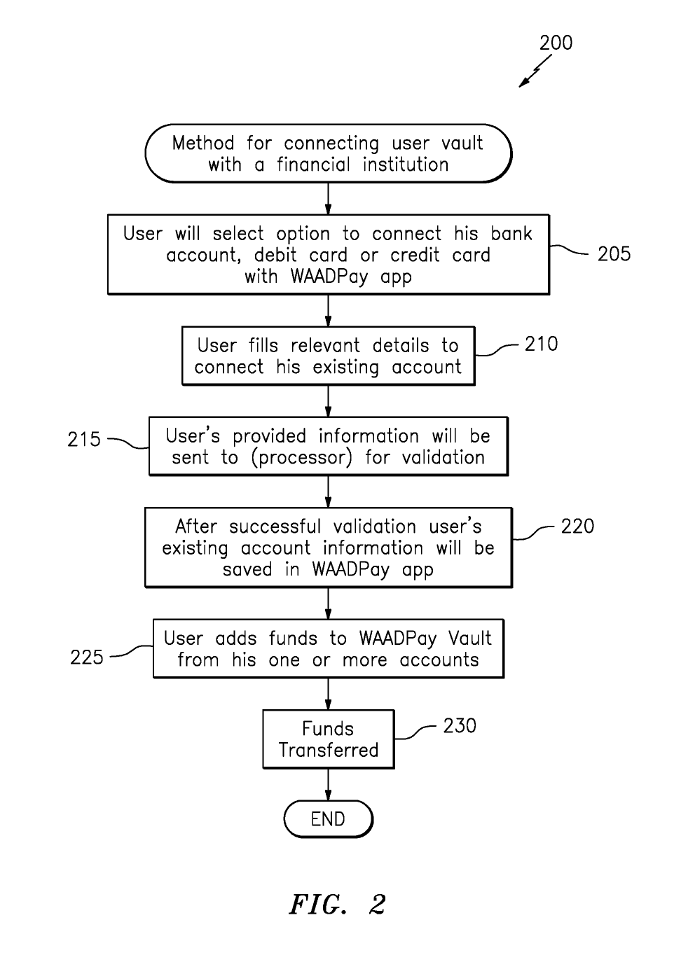

FIGS. 2-12 illustrate various exemplary user interfaces and methods for using the system 100 to reward, review and perform group payments via a user interface device 101.

To begin, each user can create a user account with system services environment 150. The account information for each created user account can be maintained in user account database 156. User account database 156 can store profile information for each user account, including a unique account identifier identifying the user account, personal information, username, password, email address, address, credit card information, banking information, client devices belonging to the user, etc. User account database 156 can also include account management information, such as content storage locations, security settings, personal configuration settings, client devices authorized to access the user account, etc. Each user account can include a user vault wherein financial information is stored and access to the same is available to the user via the App 101a on their user interface 100.

Once a user is registered, the user can communicate with site owner environment 150 via the App 101a on an interface device 101, to request to login into their user account. System services environment 150 can require that a user provide login credentials, such as a user name and password, touch identification, etc., to login into their user account. Upon receiving the correct login credentials for a user account, system services environment 150 can authorize the requesting user's client device 101 on the user account, thereby allowing client device 101 to access content items assigned to the user account, such as the user vault, for example, in order to make purchases and transfer funds to and from other users.

Upon completing the registration process, each user can utilize the App 101a to connect to their financial institution(s), in order to transfer funds to their personal vault.

FIG. 2 is a flow chart illustrating an exemplary method 200 for using the system 100 to connect with and receive funds from a financial institution 160 using an interface device 101. The method can begin at step 205, wherein the user can open the App 101a and select an option for connecting with a financial institution. Next, the method can proceed to step 210 wherein the user can input or select from a list of financial institutions and can input account and password details. Next, the method can proceed to step 215, wherein the system server 150 can transmit the information to the proprietary payment processing service 135 for validation with the banking institution. At step 220, the system can validate the user account and save the information within the storage 101b of the user device for later access. Next, at step 225, the user can select the amount of money they wish to transfer and can instruct the card processing service to make the transfer. Finally, at step 230, the funds can be transferred from the financial institution and deposited into the user vault for immediate use. Although described above as a “transfer”, the system may function in a manner similar to making a purchase, wherein the financial institution is debited the requested amount, and a credit is posted in the user vault.

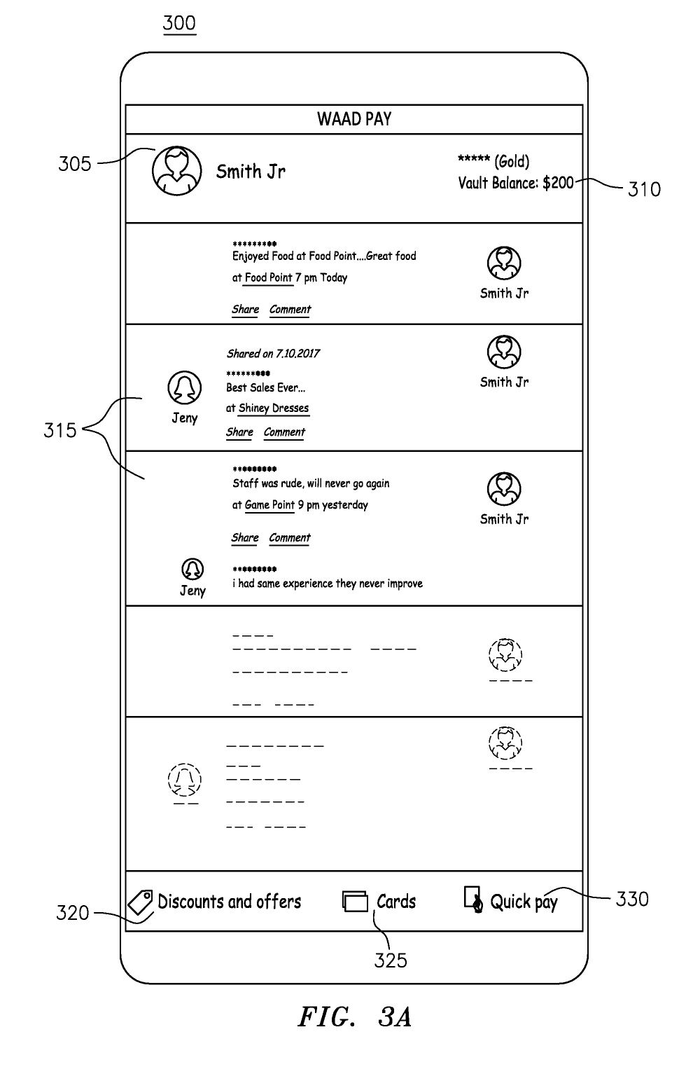

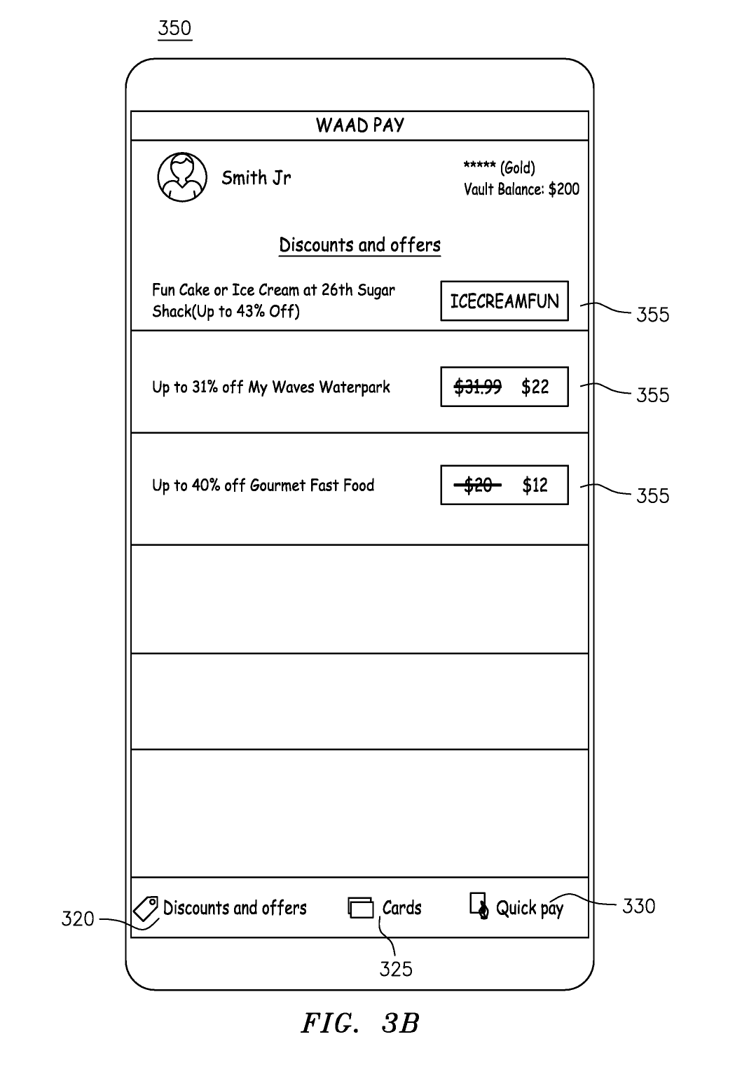

Upon completing the registration process and adding funds to their vault, users can begin using the system. To this end, FIG. 3A illustrates an exemplary user interface 300 generated by the system services environment 150 to be displayed on the App 101a of the registered user device 101. As shown, the interface 300 can provide the user with a plurality of system options and information, such as the user profile 305, the users current vault balance 310, social feeds and comments from other users, friends and family members 315, discounts and offers from participating merchants 320, virtual cards 325, and quick pay options 330.

FIG. 3B illustrates one exemplary embodiment of a user interface 350 which can be generated upon selection of option 320 by the user. As shown, the interface can provide any number of user-only discounts 355 from system merchants for use by system users.

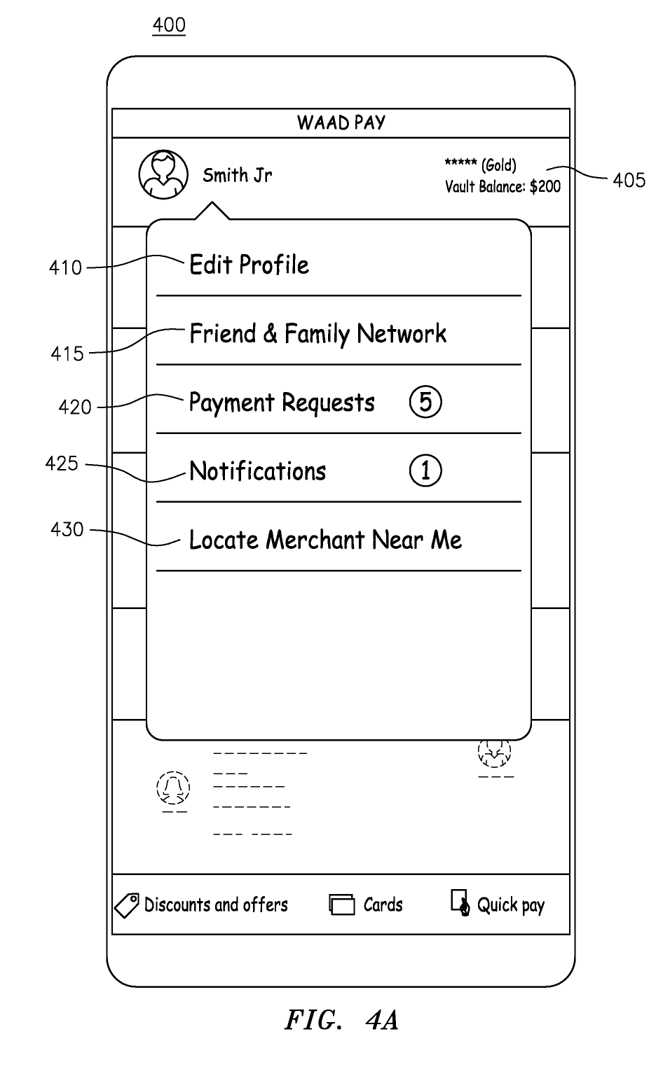

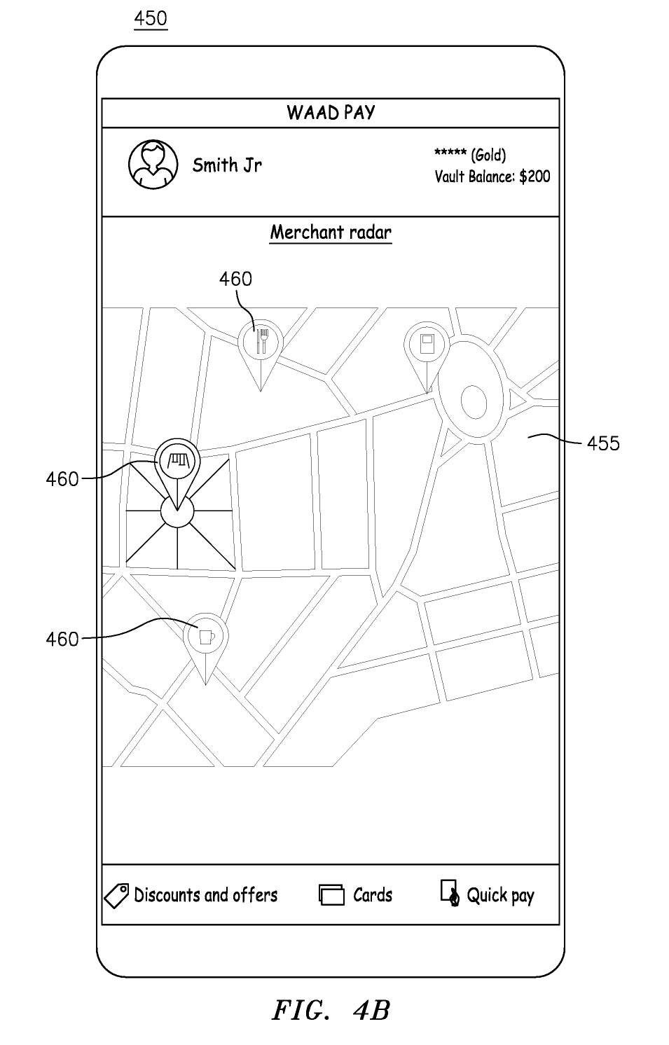

FIG. 4A illustrates an exemplary user interface 400 generated by the system services environment 150 to be displayed on the App 101a of the registered user device 101. As shown, when the user selects their profile 305, a series of user options can be provided, such as options for editing their user profile 410, and creating or updating a friend and family network 415. By selecting the friend and family network, member accounts can be linked to the user account in the expected manner by searching the system database and sending a contact request. Upon acceptance, the user accounts can be linked so as to allow free communication between the same.

Additionally, the interface 400 can also include options for allowing the user to send and receive payment requests 420, display a listing of user notifications 425 such as promotions, system alerts, friend and family requests, etc., and provide options for locating nearby merchants 430 that accept WAADPay and/or participate in the system functionality. One such example is illustrated in FIG. 4A which illustrates exemplary user interface 450. As shown, the interface can provide a user-defined map 455 onto which locator pins 460 can be provided. The map and pins can show the location of system merchants nearby to the users current or intended location. Of course, other means for displaying such information can also be provided.

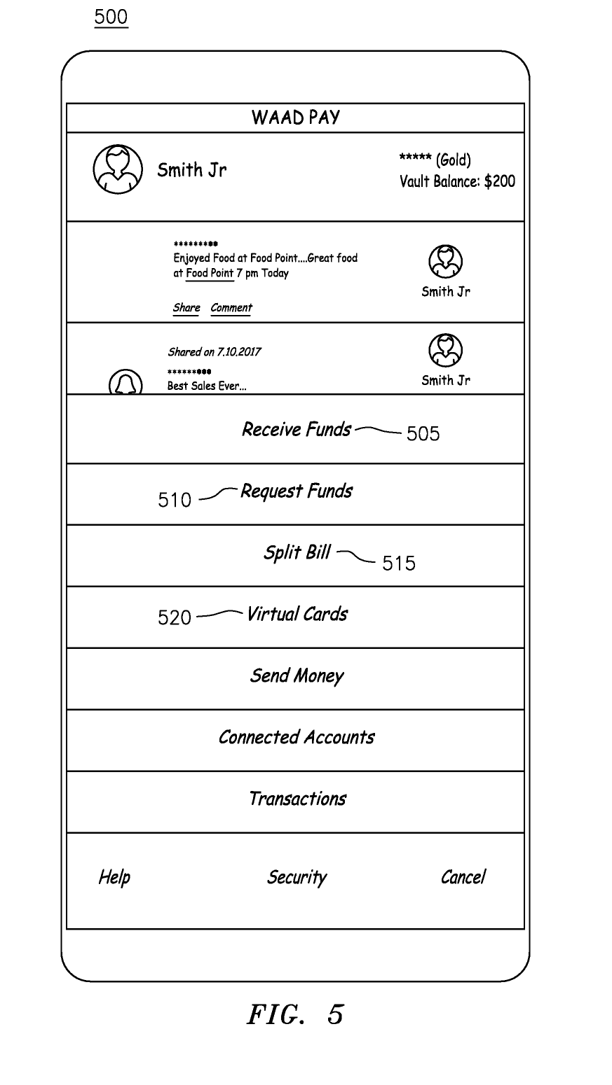

FIG. 5 illustrates an exemplary user interface 500 for allowing a user to conduct financial transactions utilizing the system 100. As shown, the user interface 500 can include options for receiving funds 505, requesting funds 510, splitting bills 515, and creating virtual cards 520, for example.

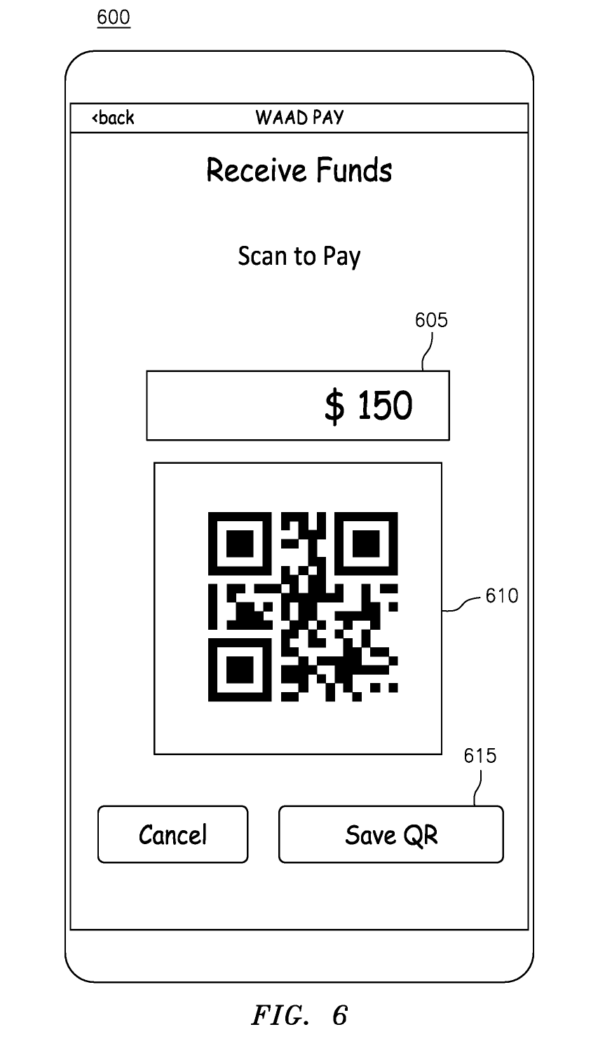

As shown in FIG. 6, upon selection of option 505 by a user, the system can allow a user to create multiple QR codes with different amounts or payment requests and save them to use for quick fund transfer requests. In one embodiment, this can be accomplished by generating exemplary user interface 600, wherein the user enters a specific dollar amount 605 beneath a system generated unique QR code 610. As described herein, it is preferred that each QR code include a set time to expire (e.g., 10 minutes), and that the code contain and/or link to encrypted and compressed information about the recipient, the amount due, the amount of time remaining until the QR code expires, and a time stamp depicting when the code was generated.

Upon saving the code at 615, the specific dollar amount will be tied to the QR code. As will be described below, other system users will be able to use the saved code to automatically transfer the specific dollar amount from their user vault to the vault of the user who created the code. Such a feature provides a simple means for transferring funds between account users via the system 100.

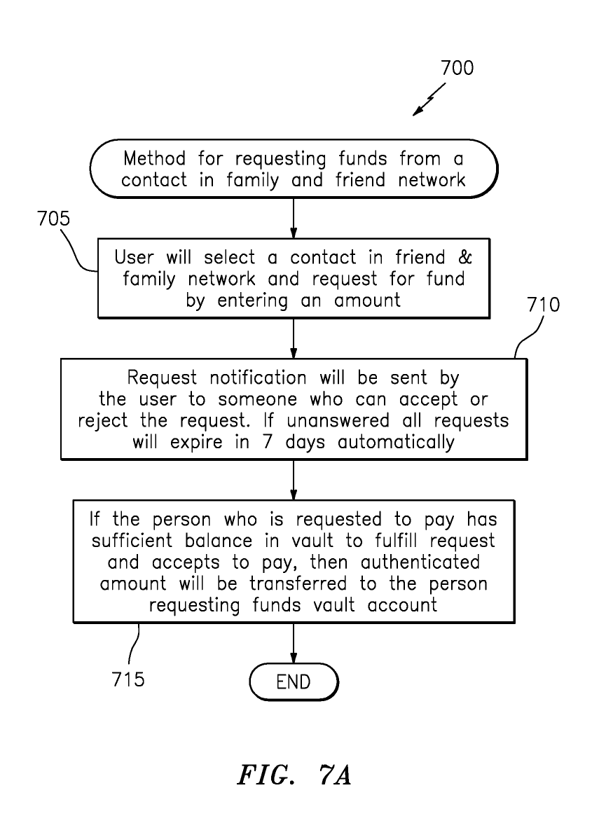

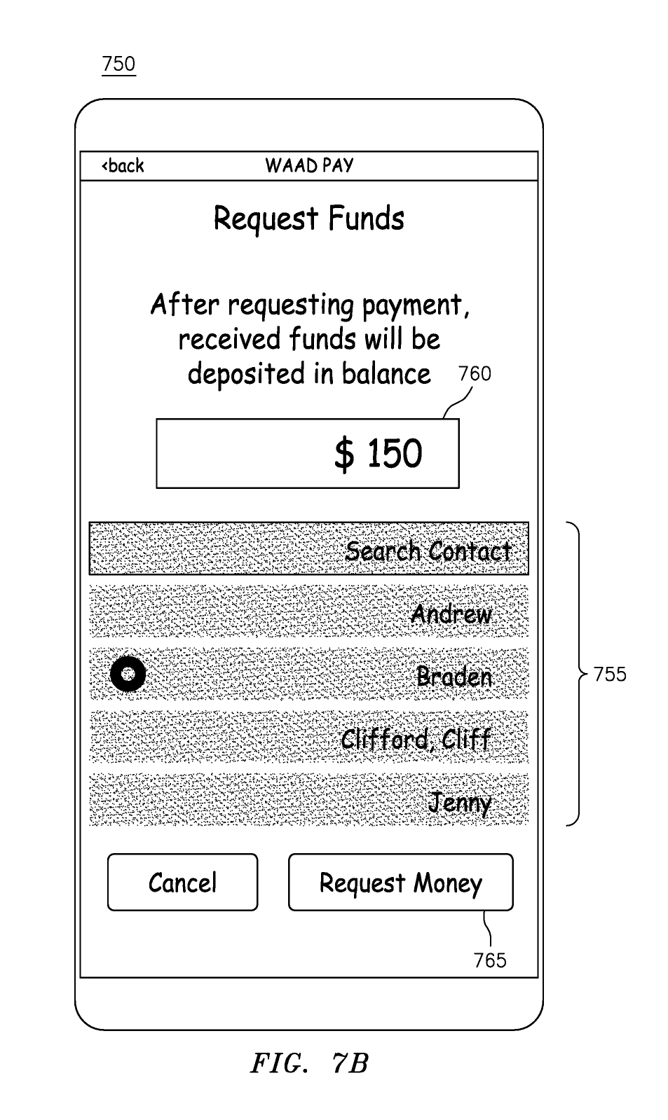

As shown in FIGS. 7A and 7B, upon selection of option 510 by a user, the system can allow the user to request funds from any of their contacts. In one embodiment, this can be accomplished by performing a method 700 utilizing exemplary user interface 750. The method can begin at step 705 wherein the user selects a contact 755 from their list of contacts, and enters the amount 760 of funds they wish to receive. At step 710, the request can be sent 765 to the selected user utilizing the system network. Upon acceptance by the recipient, the system can transfer 715 the funds from one user vault to another. Upon denial of the request, or expiration of a predetermined time period, the request will be cancelled and no funds will be transferred.

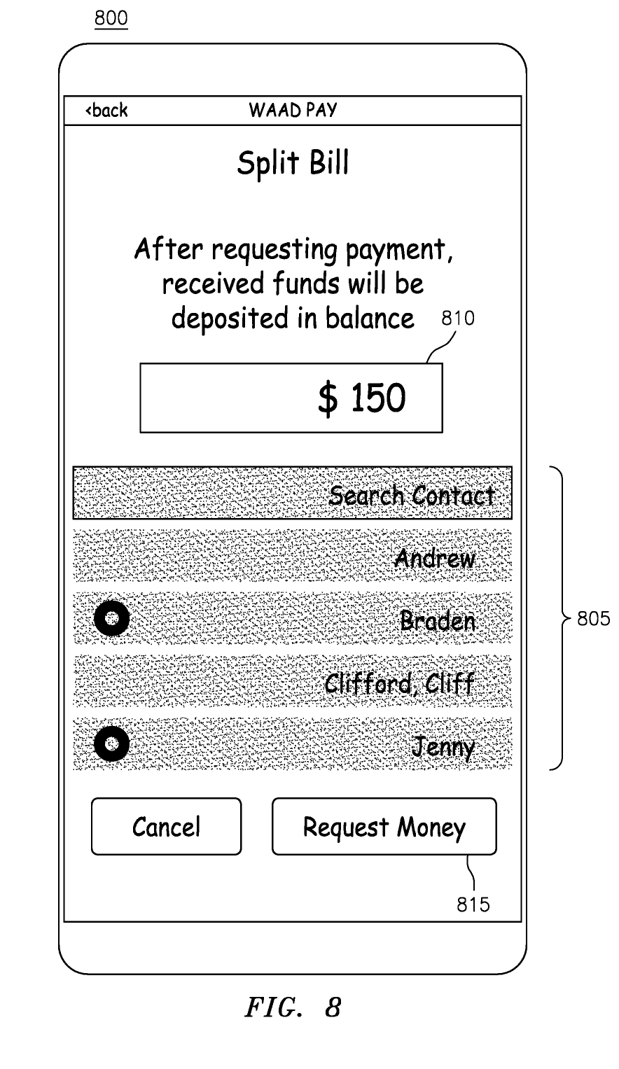

As shown in FIG. 8, upon selection of option 515 by a user, the system can allow a user to receive funds from other contacts to split a shared bill. The process can be accomplished via exemplary user interface 800 wherein the user selects a contact 805 from their list of contacts and enters the amount 810 of funds they wish to receive and sending the request 815 to the selected contact.

As shown in FIG. 9A, upon selection of option 520 by a user, the system can allow the user to create any number of virtual credit cards (i.e., WAADCards) which can be backed by the funds in the user vault. In one embodiment, this can be accomplished through the system 100 by performing a method 900. The method can begin at step 905 wherein the user creates a name for the card and moves on to step 910 wherein the user can customize how the virtual card will appear. Next, the user can instruct the system to load/transfer 915 a user defined specific dollar amount from their vault onto the card.

The system will validate the selected amount to ensure the user has sufficient balance in their user vault, and will notify the user if the specific amount is not available. This notification may include prompting the user to transfer additional funds to their vault from their financial institution 160. Upon verifying the sufficiency of the requested funds, the system 150 will communicate the information with one or both of the proprietary payment processing service 130 and/or a legacy card processing service 135 at step 920 for creation of the final virtual card, including the credit card numbers. This step can include generating any and all relevant endpoint API's with the deposit amount and/or generating or requiring a user-specified pin.

FIG. 9B illustrates an exemplary user interface 950 which can be produced by the system 100 for allowing a user to create and display their virtual credit cards. As shown, the user interface 950 can include option 955 for creating a new card utilizing the method 900 described above, and can list each additional virtual credit card 960 that belongs to the user.

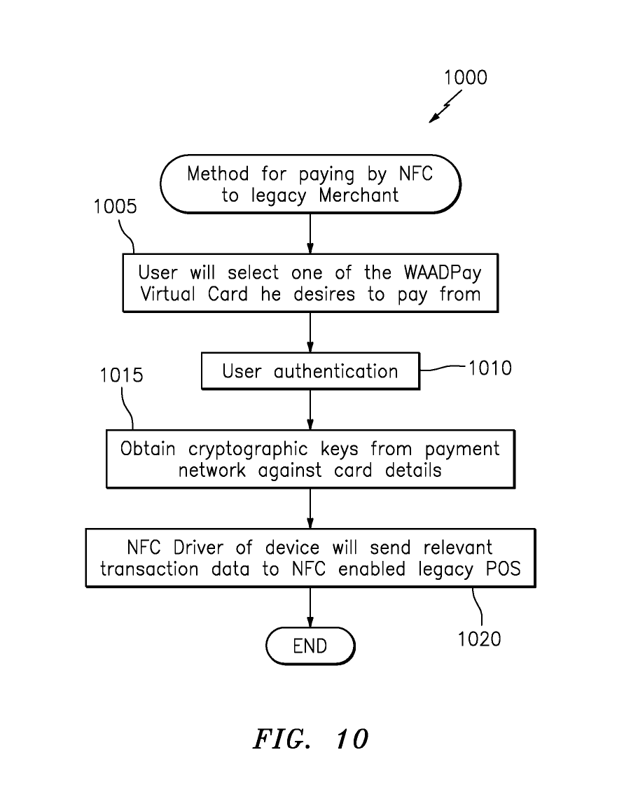

FIG. 10 is a flow chart illustrating an exemplary method 1000 for utilizing the system 100 to pay a merchant with a system-created virtual credit card utilizing the merchant's legacy point of sale system 120b. The method can begin at step 1005 wherein the user can select a virtual credit card 960 from the list of cards shown at interface 950. Next, the system can proceed to step 1010 wherein the user can be prompted to enter their pin or other authentication method. Upon successful user authentication, the system can proceed to step 1015 wherein cryptographic keys from the payment network will be compared to the selected card detail, before concluding with step 1020 wherein the Near Field Communication driver of the user device 101 will be activated to conduct the transaction with the Merchant Point of sale terminal. As the specifics for conducting NFC transactions between portable electronic devices and POS terminals are known, no further description is provided.

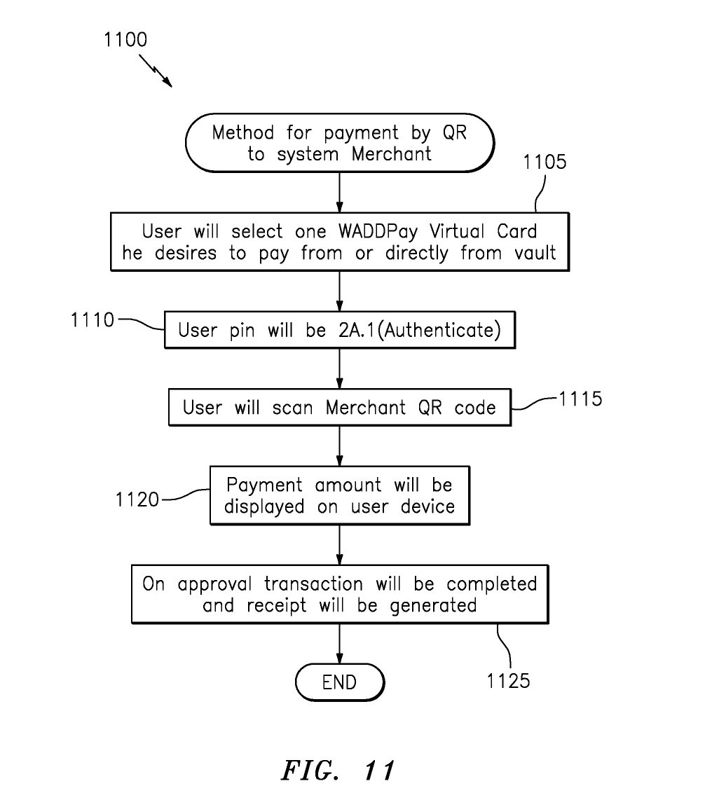

FIG. 11 is a flow chart illustrating an exemplary method 1100 for utilizing the system 100 to pay a merchant with a system-created virtual credit card utilizing a QR code. The method can begin at step 1105 wherein the user can select a virtual credit card 960 from the list of cards shown at interface 950. Next, the system can proceed to step 1110 wherein the user can be prompted to enter their pin or other authentication method. Upon successful user authentication, the system can proceed to step 1115 wherein the user can scan a Merchant generated QR code. The process for creating a merchant-generated QR code is identical to that described above at FIG. 6. Upon scanning the Merchant QR code, the user device 101 can display the amount to be debited from their virtual credit card at step 1120 and the user can approve the same by clicking “accept” on the App 101a at step 1125.

Upon the conclusion of methods 1000 and 1100, the system can generate a payment receipt for the user's records, and provide the ability for the user to immediately leave a review for the merchant. Such a feature is particularly advantageous, as studies show the longer a customer waits to review a product or service the less likely they are to ever do so. As such, by providing a way to ensure all customers are prompted to leave an immediate review as a part of the payment process, the system provides merchants with a significant opportunity to receive reviews in much greater numbers than utilizing traditional methods.

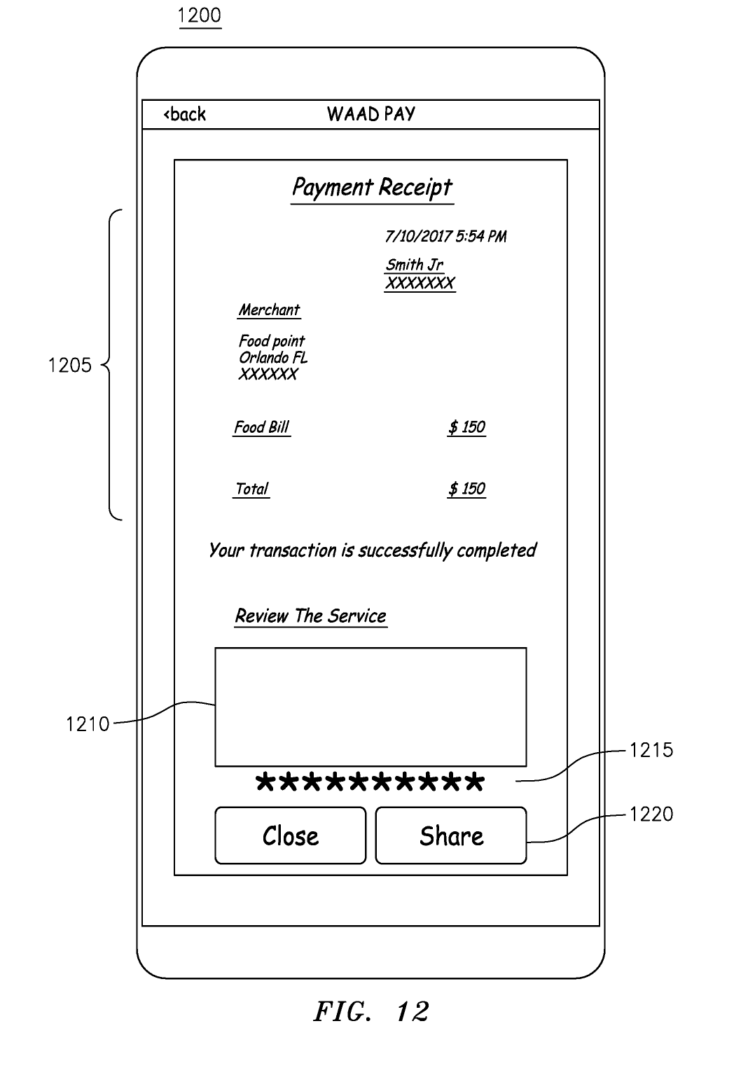

FIG. 12 illustrates an exemplary user interface 1200 which can be produced by the system 100 for allowing a user to immediately leave a review upon paying for a product or service. As shown, the screen 1200 can include an itemized receipt portion 1205, and a comment box 1210 into which the user can provide detailed comments about the level of service they received. Additional ranking mechanisms such as a “star rating” 1215, for example can also be provided. Upon leaving the review, the user can click the share button 1220 to allow their review to be seen by their network of friends and family, who may also provide additional comments. Moreover, the user reviews can be listed on the merchants' page within the system and can also be shown on the list of nearby merchants, such as that shown at FIG. 4B, for example.

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

Accordingly, a novel system and method for achieving user specified online advertising in a manner that greatly benefits consumers, advertisers and publishers is disclosed. As to a further description of the manner and use of the present invention, the same should be apparent from the above description. Therefore, no further discussion relating to the manner of usage and operation is provided.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for providing improved communication and payment options between merchants and consumers, said system comprising:
at least one user interface device for operation by a consumer;
at least one merchant interface device for operation by a merchant;
a system services environment comprising at least one computer system, at least one database, and a plurality of system-implemented secure user vaults, each of the user vaults being associated with a single user account; and
a communications network that is connected to each of the at least one user interface device, the at least one merchant interface device, the system services environment and at least one financial institution,
wherein the database includes instructions for utilizing a first user interface device to transfer funds from a first financial institution to a first user vault;
wherein the at least one computer is programmed to generate one or more virtual credit cards that are financially linked to the first user vault upon receiving user instructions from the first user interface device; and
wherein the first user interface device and the merchant interface device are programmed to conduct a financial transaction, said financial transaction including debiting funds from the first user vault and crediting funds to a user account of the merchant.

2. The system of claim 1, further comprising:
a point of sale device that is communicatively linked with the merchant interface device; and
a legacy card processing network that is communicatively linked with the point of sale device and the financial institution,
wherein the financial transaction is conducted through the point of sale device and via the legacy card processing network.

3. The system of claim 1, further comprising:
a proprietary payment processing network that is communicatively linked between the system services environment and the financial institution,
wherein the financial transaction is conducted electronically through the system services environment via the proprietary payment processing network.

4. The system of claim 1, wherein the user interface device and the merchant interface device are connected electronically via a near field communication device during the financial transaction.

5. The system of claim 1, wherein the merchant interface device is programmed to generate a QR code representing a payment request to be deposited into a linked merchant account.

6. The system of claim 5, wherein the first user interface device is programmed to scan the QR code of the merchant interface device and to receive the payment request.

7. The system of claim 6, wherein the at least one computer is programmed to transfer funds from the first user vault to the merchant account when the generated QR code is scanned by the first user interface device.

8. The system of claim 7, wherein the at least one computer is programmed to generate a merchant review presentation screen on the first user interface device and to share a user review with other system users.

9. The system of claim 1, wherein each of the user interface devices are programmed to generate a QR code representing a payment request to be deposited into an associated user account.

10. The system of claim 9, wherein each of the user interface devices are programmed to scan the QR code of another user interface device and to receive the payment request.

11. The system of claim 10, wherein the at least one computer is programmed to transfer funds from a user vault associated with one user interface device to another user vault associated with another user interface device upon receipt of a scanned QR code.

12. A computer implemented method for conducting financial transactions, the method comprising:
providing at least one user interface device for operation by a consumer;
providing at least one merchant interface device for operation by a merchant;
providing a system services environment comprising at least one computer system and database
communicatively linking each of the at least one user interface device and the at least one merchant interface device,
generating, via the at least one computer system, a system-implemented secure user vault for each user account;
storing, via the database, each of the system implemented secure user vaults;
transferring, via a communications network, funds from a financial institution to the user vault of a user account upon receiving user instructions via a user interface device;
generating, via the at least one computer system, one or more virtual credit cards which are financially linked to the user vault upon receiving user instructions via a user interface device; and
conducting a financial transaction between a user interface device and a merchant interface device, said financial transaction including debiting funds from the user vault of the user account associated with the user interface used for the transaction.

13. The method of claim 12, further comprising:
conducting the financial transaction via near field communication between a merchant point of sale device and the first user interface device.

14. The method of claim 12, further comprising:
generating, via the merchant interface device, a QR code representing a payment request to be deposited into a linked merchant account.

15. The method of claim 14, further comprising:
scanning, via the first user interface device, the QR code generated by the merchant interface device.

16. The method of claim 15, further comprising:
transferring, via the at least one computer system, funds from the first user vault to the merchant account upon notification from the first user interface device that the generated QR code has been scanned.

17. The method of claim 16, further comprising:
generating, via the first user interface device, a merchant review presentation screen,
uploading a merchant review to the database, and
sharing the uploaded merchant review with other system users.
